(19) United States
(12) Patent Application Publication
(10) Pub. No.: US 2014/0354525 A1
(43) Pub. Date: Dec. 4, 2014

(54) OLED BACKLIGHT MODULE

(71) Applicant: HON HAI PRECISION INDUSTRY CO., LTD., New Taipei (TW)

(72) Inventor: PO-CHOU CHEN, New Taipei (TW)

(21) Appl. No.: 13/907,989

(22) Filed: Jun. 3, 2013

(51) Int. Cl. G09G 3/32

(52) U.S. Cl. CPC G09G 3/3208
USPC 345/102

(57) ABSTRACT

A backlight module includes a light guiding board and an OLED light bar. The light guiding board includes a light emitting surface, a light reflecting surface opposite to the light emitting surface, and a lateral surface interconnecting the light emitting surface and the light reflecting surface. The OLED light bar is located besides an edge side of the light guiding board, and face towards the lateral surface of the light guiding board. The backlight module has a good light quality.

### BACKGROUND

1. Technical Field

The present disclosure relates to backlight modules, and more particularly to an OLED (organic light emitting diode) backlight module for an LCD (light crystal display) panel.

2. Description of Related Art

LEDs (light emitting diodes) have been widely promoted as light sources of electronic devices owing to many advantages, such as high luminosity, low operational voltage and low power consumption. An LED backlight module of an LCD (liquid crystal display) panel includes a light guiding board and a plurality of LED light sources located at one edge side of the light guiding board, and an air gap is defined between the adjacent LED light sources. Therefore, a dark zone is defined between the adjacent LED light sources, whereby causes light quality of the LCD panel to be bad.

Therefore, an OLED backlight module capable of overcoming the above described shortcomings is desired.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 shows a schematic view of an OLED backlight module in accordance with an embodiment of the present disclosure.

FIG. 2 shows a top view of the OLED backlight module of FIG. 1.

### DETAILED DESCRIPTION

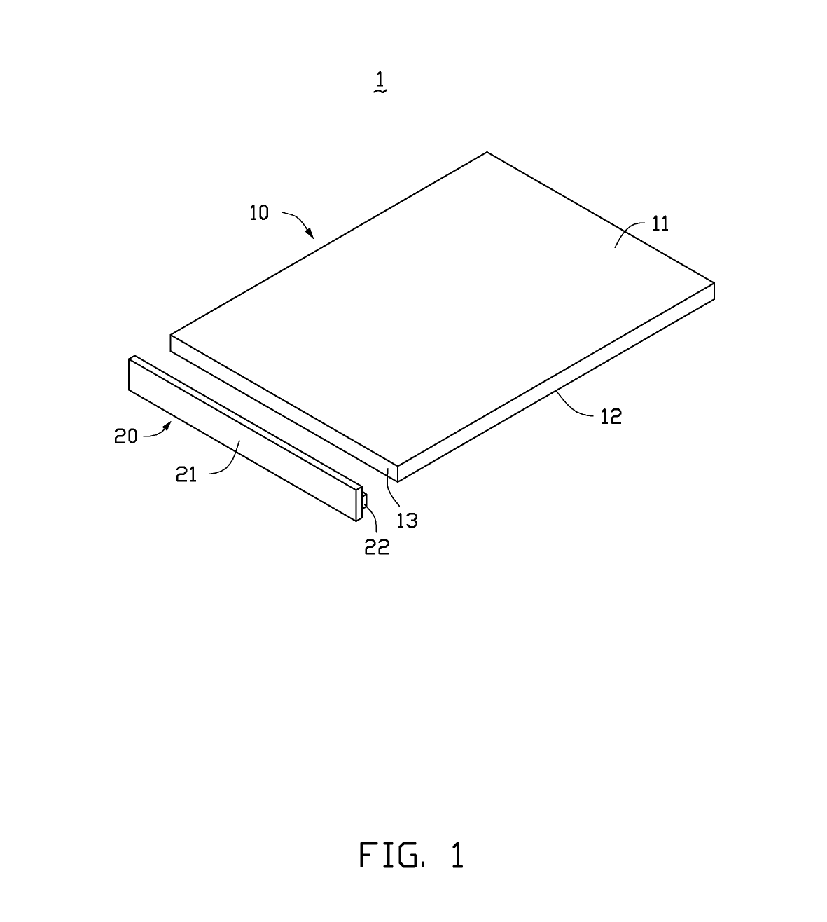

Referring to FIG. 1, an OLED backlight module 1 in accordance with an exemplary embodiment of the present disclosure includes a light guiding board 10, and an OLED light bar 20 located at a lateral side of the light guiding board 10.

The light guiding board 10 is a thin and flat board. The light guiding board 10 includes an upper surface 11, a lower surface 12 opposite to the upper surface 11, and four edge sides 13 interconnecting the upper surface 11 and the lower surface 12. In this embodiment, the edge sides 13 each are perpendicular to the upper surface 11 and the lower surface 12. The upper surface 11 is a light output surface for outputting light to an LCD panel (not shown), while the lower surface 12 is a light reflecting surface. The area of each of the upper and lower surfaces 11, 12 is quite larger than the area of each of the edge sides 13.

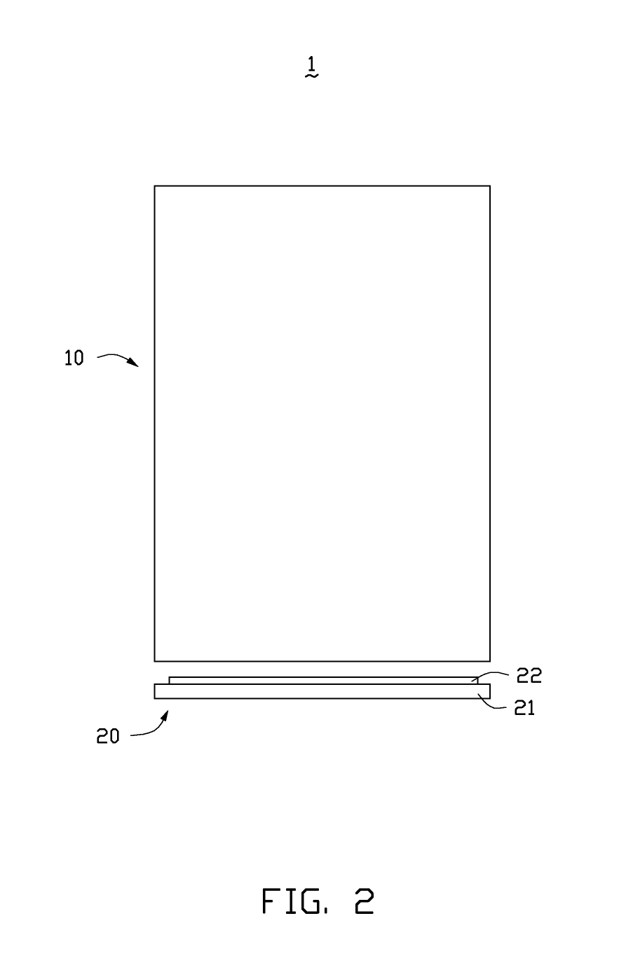

Referring to FIG. 2, the OLED light bar 20 is located at one edge side 13 of the light guiding board 10, and the OLED light bar 20 is spaced from the corresponding edge side 13. The OLED light bar 20 includes a substrate 21 and a plurality of continuous OLEDs 22 located on the substrate 21, and the OLEDs 22 face the corresponding edge side 13.

The OLED 22 includes thin and transparent ITO with semiconductor characteristic. A positive electrode of the power, the ITO, organic material and a metal negative electrode are packaged into a sandwich structure of the OLED 22. The OLED 22 includes a hole transport layer, a light emitting layer and an electron transport layer. When the power supplies appropriate voltage, the positive hole and negative electron will be combined in the light emitting layer, then photons will be produced. As different organic material of the OLED 22, the OLED 22 produces red, green and blue basic color. Due to the OLED 22 being continuous distributed, the OLED light bar 20 will not define dark zone, whereby improving the light quality of the OLED backlight module 1. It is to be understood that the OLED light bars 20 can be located at one or more of the other edge sides 13. The OLED light bar 20 is made in a manner of evaporation, and the OLED 22 is made of organic molecules or high polymer material.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An OLED backlight module, comprising:
a light guiding board, the light guiding board comprising a light emitting surface, a light reflecting surface opposite to the light emitting surface, and a lateral surface interconnecting the light emitting surface and the light reflecting surface; and
an OLED light bar located besides an edge side of the light guiding board, the OLED light bar facing the lateral surface of the light guiding board.

2. The OLED backlight module of claim 1, wherein the OLED light bar comprises a substrate and a plurality of continuous OLEDs located on the substrate, and the OLEDs face the edge side.

3. The OLED backlight module of claim 2, wherein the OLED is made in a manner of evaporation.

4. The OLED backlight module of claim 3, wherein the OLED is made of organic molecules material.

5. The OLED backlight module of claim 3, wherein the OLED is made of high polymer material.

6. The OLED backlight module of claim 1, wherein the OLED light bar is spaced from the lateral surface of the light guiding board.

7. The OLED backlight module of claim 1, wherein the lateral surface is perpendicular to the light emitting surface of the light guiding board.
